(19) United States
(12) Patent Application Publication
(10) Pub. No.: US 2026/0354298 A1
(43) Pub. Date: Nov. 12, 2026

(54) INTELLIGENT NO - TILL SEEDING UNIT FOR WHEAT

(71) Applicant: NORTHWEST A&F UNIVERSITY, Xianyang (CN)

(72) Inventors: Hongbo Zhao, Xianyang (CN); Yizhe Zhang, Xianyang (CN); Lihua Dang, Xianyang (CN); Xianghui Li, Xianyang (CN); Zuoli Fu, Xianyang (CN); Zhiqi Zheng, Xianyang (CN); Yuxiang Huang, Xianyang (CN)

(21) Appl. No.: 19/201,768

(22) Filed: May 7, 2025

(51) Int. Cl. A01C 7/06; A01C 5/06

(52) U.S. Cl. CPC A01C 7/06; A01C 5/064; A01C 5/068

(57) ABSTRACT

The present invention provides an intelligent no-till seeding unit for wheat, which includes a ground-following suspension system, a measurement and control device, a pressing mechanism, an inclined rotary tillage blade set, and a ditching mechanism, etc. The ground-following suspension system is installed at the front part of the frame; The measurement and control device, the ditching mechanism, and the pressing mechanism and the inclined rotary tillage blade set is installed at the bottom of the frame. The present invention can realize the rotary tillage anti-blocking and no-till seeding of a single wheat unit, ensure the ditching and seeding depth, solve the problems that profiling cannot be achieved between rows during wheat no-till or reduced-till seeding, and provide technical support for subsequent research.

### TECHNICAL FIELD

The present invention relates to the technical field of agricultural machinery, in particular to an intelligent no-till seeding unit for wheat.

### BACKGROUND

Conservation tillage has the effects of improving the physical and chemical structure of the soil, preventing wind and water erosion, and reducing costs and increasing efficiency. No-till or minimum-till seeding is one of the important technical links in the wheat conservation tillage system. Directly seeding wheat in the fields covered with previous crop straws has two main difficulties. One is that a large amount of straw on the surface is likely to entangle and block the machinery. The other is that without tillage and land preparation before seeding, the surface is uneven, and it is difficult to maintain a consistent seeding depth, so profiling is required. The existing wheat no-till or minimum-till seeding generally adopts drive anti-blocking, installing multiple rotary tillage blades on one shaft to cut and throw the straws to achieve anti-blocking. The profiling effect is poor, and the rotation speed cannot be adjusted, making it unable to adapt to different forward speeds.

Therefore, how to provide an intelligent no-till seeding unit for wheat that integrates an anti-blocking device, a seed-fertilizer box replenishment device, a ditching device, and a pressing device, which can not only accurately match the forward speed of the seeder with the rotation speed of the rotary tillage blades, but also adjust the ground-clearance and the pressing force of the unit according to different field conditions is an urgent problem to be solved by those skilled in the art.

### SUMMARY

The objective of the present invention is to provide an intelligent no-till seeding unit for wheat, which can realize the no-till or minimum-till seeding of a single wheat unit, solve the problems of inability to profile between rows and low profiling accuracy within rows during seeding, and intelligently adjust the rotation speed of the rotary tillage blades according to the forward speed, and adjust the ground-clearance and the pressing force in real-time according to the surface conditions.

The present invention adopts the following technical solutions to solve the technical problems: An intelligent no-till seeding unit for wheat includes: a profiling ground-following suspension system, a measurement and control device, a seed-fertilizer box replenishment device, a frame, a pressing mechanism, an inclined rotary tillage blade set, and a ditching mechanism;

The profiling ground-following suspension system is installed at the front part of the frame; the seed and fertilizer box device is installed on the top of the frame, the ditching mechanism is installed in the middle of the bottom end of the frame and is communicated with the seed-fertilizer box replenishment device; the inclined rotary tillage blade set is installed at the front part of the bottom end of the frame, and the pressing mechanism is installed at the rear part of the bottom end of the frame. The measurement and control device is installed inside the frame and is electrically connected to the profiling ground-following suspension system, the seed-fertilizer box replenishment device, the pressing mechanism, and the inclined rotary tillage blade set respectively.

Further, the profiling ground-following suspension system includes a four-bar mechanism and an electric push rod for driving the four-bar mechanism. The central positions of the first bent rod, the second bent rod, the third bent rod, and the fourth bent rod of the four-bar mechanism are all provided with holes. The third bent rod and the fourth bent rod are provided with holes at both sides. The electric push rod has holes at both ends. The riveting bolt of the profiling mechanism connects the electric push rod and the four-bar mechanism, and the locking bolt and the installation bolt fix the components.

Further, the profiling mechanism comprises a four-bar linkage and an electric push rod for driving the four-bar linkage. The center positions of the first bent rod, the second bent rod, the third bent rod, and the fourth bent rod of the four-bar linkage are all provided with holes, namely Hole 1, Hole 2, Hole 3, and Hole 4 respectively. Holes 5 and 6 are provided at both sides of the third bent rod and the fourth bent rod. The two ends of the electric push rod are respectively provided with Hole 7 and Hole 8. The riveting bolt of the profiling ground-following suspension system passes through Hole 1, Hole 7, and Hole 2 and is tightened by Nut 1 to connect the electric push rod with the four-bar linkage. The locking bolt of the profiling ground-following suspension system passes through Hole 5, Hole 8, and Hole 6 and is tightened by Nut 2 to fix the electric push rod and the four-bar linkage together. The mounting bolt and Nut 3 of the profiling ground-following suspension system are used to fix the first bent rod and the second bent rod.

Further, the inclined rotary tillage blade set comprises a rotary tillage blade support arm, rotary tillage blades, rotary tillage blade seats, a rotary tillage blade disc, a rotary tillage blade motor, a rotary tillage blade top plate, a rotary tillage blade power cord, a rotary tillage blade motor fixing bolt, and a rotary tillage blade fixing bolt. The rotary tillage blade disc has six screw holes for fixing the disc to the output shaft of the rotary tillage blade motor.

The rotary tillage blade top plate is provided with Rotary Tillage Blade Top-plate Hole 1, Rotary Tillage Blade Top-plate Hole 2, Rotary Tillage Blade Top-plate Hole 3 and Rotary Tillage Blade Top-plate Hole 4 for fixing the rotary tillage blade support arm. The angle α between the straight line formed by Rotary Tillage Blade Top-plate Hole 1 and Rotary Tillage Blade Top-plate Hole 2 and the vertical direction is 10°. The angle β between the straight line formed by Rotary Tillage Blade Top-plate Hole 3 and Rotary Tillage Blade Top-plate Hole 4 and the vertical direction is 10°. Rotary Tillage Blade Top-plate Hole 1, Rotary Tillage Blade Top-plate Hole 2, Rotary Tillage Blade Top-plate Hole 3 and Rotary Tillage Blade Top-plate Hole 4 are connected with the corresponding holes on the rotary tillage blade support arm by bolts.

A plurality of rotary tillage blade seats are uniformly and fixedly connected to the cylindrical surface of the rotary tillage blade disc, and there is a certain distance between the disc and the rotary tillage blade motor. A planar rotary tillage blade is fixedly connected in each rotary tillage blade seat.

Further, the plane where the rotary tillage blade disc is located has an inclination angle of 80 degrees relative to the vertical plane where the central axis of the seeder is located, and the center-to-center distance between two adjacent discs is 190 mm.

Further, the diameter of the rotary tillage blade disc is 45 mm, the turning radius of the rotary tillage blade seat is 100 mm, and the turning radius of the rotary tillage blade is 225 mm.

Further, the seed-fertilizer box replenishment device comprises a seed box, seed box support bolts, a seed box support plate, a seed metering shaft motor, a fertilizer metering shaft motor, and a fertilizer box. The bottom end of the seed box support plate is fixed on the frame. Both the seed box and the fertilizer box are fixedly installed on the seed box support plate through the seed box support bolts. The seed metering shaft motor is located at the outlet of the seed box and is used to adjust the rotation speed of the seed metering shaft. The fertilizer metering shaft motor is located at the outlet of the fertilizer box and is used to adjust the rotation speed of the fertilizer metering shaft.

Further, the ditching mechanism comprises a furrow opener connector, a furrow opener and a fertilizer discharge pipe. The furrow opener connector is fixed to the frame by bolts. The furrow opener is installed at the front of the furrow opener connector and is in communication with the outlet of the seed box. The fertilizer discharge pipe is installed at the rear of the furrow opener connector and is in communication with the outlet of the fertilizer box.

Further, the pressing mechanism includes a pressing wheel device support, a pressing wheel support arm, a pressing wheel connecting bolt, a pressing wheel adjusting push rod, and a pressing wheel. One end of the pressing wheel device support is fixedly installed at the rear of the frame, and the other end is rotatably connected to the pressing wheel. The pressing wheel adjusting push rod is provided with Hole 9 and Hole 10, and the pressing wheel support arm is provided with Hole 11 and Hole 12. Hole 9 is used for connection with the frame. The pressing wheel connecting bolt passes through Hole 11, Hole 10, and Hole 12 respectively to connect the pressing wheel adjusting push rod and the pressing wheel support arm.

Further, the measurement and control device comprises a control system power supply, an STM32 control board, a BMX055 attitude sensor for measuring the attitude and displacement of the frame, a measurement and control device substrate, an HC-SR04 ultrasonic sensor, and a battery. The HC-SR04 ultrasonic sensor is arranged at the bottom of the inclined rotary tillage blade set and is used to measure the ground clearance information of the seeding unit. The measurement and control device substrate and the battery are both installed on the frame, and the control system power supply, the STM32 control board, and the BMX055 attitude sensor are all integrated on the measurement and control device substrate.

Beneficial effects of the present invention:
(1). Each set of inclined rotary tillage blade sets is driven by a single rotary tillage blade motor. In this seeding unit, the existing rotary tillage anti-blocking device of the wheat no-till seeder is replaced with an electric rotary tillage anti-blocking unit, which is integrated with the seed-fertilizer box replenishment device, furrow opener, pressing wheel, etc. on the seeding unit. This realizes the no-till or minimum-till seeding of a single wheat unit and facilitates inter-row profiling.
(2) The plane where the rotary tillage blades are located forms a certain angle with the forward direction of the seeder, enabling the rotary tillage blades to have a lateral velocity. This facilitates the scattering of straw from the seedbed to the inter-rows, achieving a better effect of clearing straw from the seedbed. The magnitude of this angle can be adjusted by setting the angles of α and β.
(3). The rotational speed of the rotary tillage blade motor can be matched with the forward speed of the machine to ensure the anti-blocking performance and the quality of seedbed preparation, thus enabling high-speed no-till seeding of wheat.
(4). By relying on the BMX055 attitude sensor and the HC-SR04 ultrasonic sensor on the seeder body, data such as the real-time inclination angle and ground clearance of the machine body can be obtained. The seeding depth is calculated, and the ground clearance of the seeder is adjusted through the electric push rod to improve the consistency of the seeding depth.
(5). The pressing force of the pressing wheel can be adjusted through the pressing wheel adjusting push rod to enhance the soil-covering and pressing effect of the seeder.

### BRIEF DESCRIPTION OF DRAWINGS

FIG. 1 is a three-dimensional structural schematic diagram of the single-unit no-till wheat seeder of the present invention.

FIG. 2 is a front-view structural schematic diagram of the single-unit no-till wheat seeder of the present invention.

FIG. 3 is an exploded assembly diagram of the profiling ground-following suspension system of the present invention.

FIG. 4 is an exploded installation diagram of the four-bar mechanism, the electric push rod, and the fixing structure in the profiling ground-following suspension system of the present invention.

FIG. 5 is a structural schematic diagram of the inclined rotary tillage blade set of the present invention.

FIG. 6 is a structural diagram of the rotary tillage blade top plate in the inclined rotary tillage blade set of the present invention.

FIG. 7 is an exploded assembly diagram of the inclined rotary tillage blade set of the present invention.

FIG. 8 is a structural schematic diagram of the ditching mechanism of the present invention.

FIG. 9 is a structural schematic diagram of the seed-fertilizer box replenishment device of the present invention.

FIG. 10 is a structural schematic diagram of the measurement and control device of the present invention.

FIG. 11 is an exploded assembly diagram of the pressing mechanism of the present invention.

Among them, in the figures:
1—Profiling ground-following suspension system; 101—Four-bar mechanism; 1011—First bent rod; 1012—Second bent rod; 1013—Third bent rod; 1014—Fourth bent rod; 10111—Hole 1; 10121—Hole 2; 10131—Hole 3; 10141—Hole 4; 10132—Hole 5; 10142—Hole 6; 1021—Hole 7; 1022—Hole 8; 102—Electric push rod; 103—Nut 1; 104—Riveting bolt of the profiling device; 105—Locking bolt of the profiling ground-following suspension system; 106—Mounting bolt of the profiling ground-following suspension system; 107—Nut 3; 108—Nut 2; 2—Measurement and control device; 201—Control system power supply; 202—STM32 control board; 203—BMX055 attitude sensor; 204—Measurement and control device substrate; 3—Battery; 10—HC-SR04 ultrasonic sensor; 4—Seed-fertilizer box replenishment device; 401—Seed box; 402—Seed box support bolt; 403—Seed box support plate; 404—Seed-discharging shaft motor; 405—Fertilizer-discharging shaft motor; 406—Fertilizer box; 5—Frame; 6—Pressing wheel adjusting push rod; 7—Pressing mechanism; 701—Pressing wheel device support; 702—Pressing wheel support arm; 703—Pressing wheel connecting bolt; 704—Pressing wheel; 7021—Hole 11; 7022—Hole 12; 8—Inclined rotary tillage blade set; 801—Rotary tillage blade support arm; 802—Rotary tillage blade; 803—Rotary tillage blade seat; 804—Rotary tillage blade disc; 805—Rotary tillage blade motor; 806—Rotary tillage blade top plate; 807—Rotary tillage blade power cord; 808—Rotary tillage blade motor fixing bolt; 809—Rotary tillage blade fixing bolt; 9—Ditching mechanism; 901—Ditching device; 902—Fertilizer-discharging pipe; 903—Ditching device connector; 10—HC-SR04 ultrasonic sensor.

### DESCRIPTION OF EMBODIMENTS

To make the objectives, technical solutions, and advantages of the embodiments of the present invention clearer, the technical solutions in the embodiments of the present invention will be clearly and completely described below in conjunction with the accompanying drawings in the embodiments of the present invention. Apparently, the described embodiments are part of the embodiments of the present invention, not all of them. Based on the embodiments of the present invention, all other embodiments obtained by those of ordinary skill in the art without creative efforts shall fall within the protection scope of the present invention.

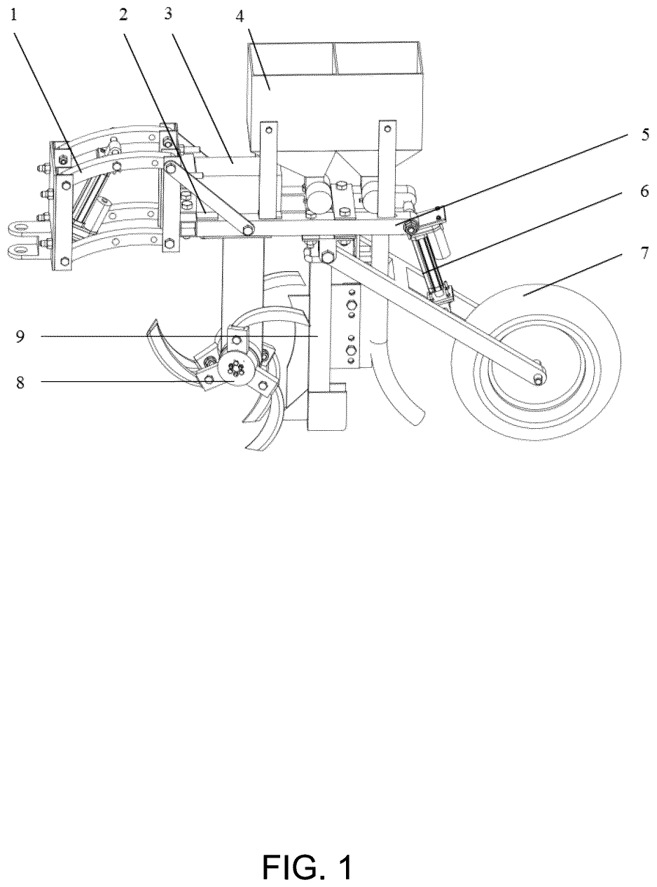

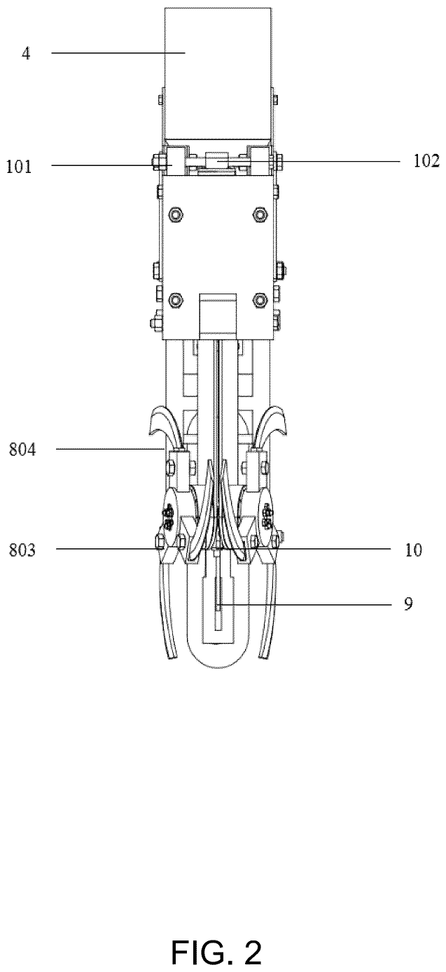

Referring to FIG. 1 and FIG. 2, the present invention provides an intelligent no-till seeding unit for wheat, which includes: a profiling ground-following suspension system 1, a measurement and control device 2, a seed-fertilizer box replenishment device 4, a frame 5, a pressing mechanism 7, an inclined rotary tillage blade set 8, and a ditching mechanism 9;

The profiling ground-following suspension system 1 is installed at the front part of the frame 5. The seed-fertilizer box replenishment device 4 is installed on the top of the frame 5. The ditching mechanism 9 is installed in the middle of the bottom end of the frame 5 and is in communication with the seed-fertilizer box replenishment device 4. The inclined rotary tillage blade set 8 is installed at the front part of the bottom end of the frame 5, and the pressing mechanism 7 is installed at the rear part of the bottom end of the frame 5. The measurement and control device 2 is installed inside the frame 5 and is electrically connected to the profiling ground-following suspension system 1, the seed-fertilizer box replenishment device 4, the pressing mechanism 7, and the inclined rotary tillage blade set 8 respectively.

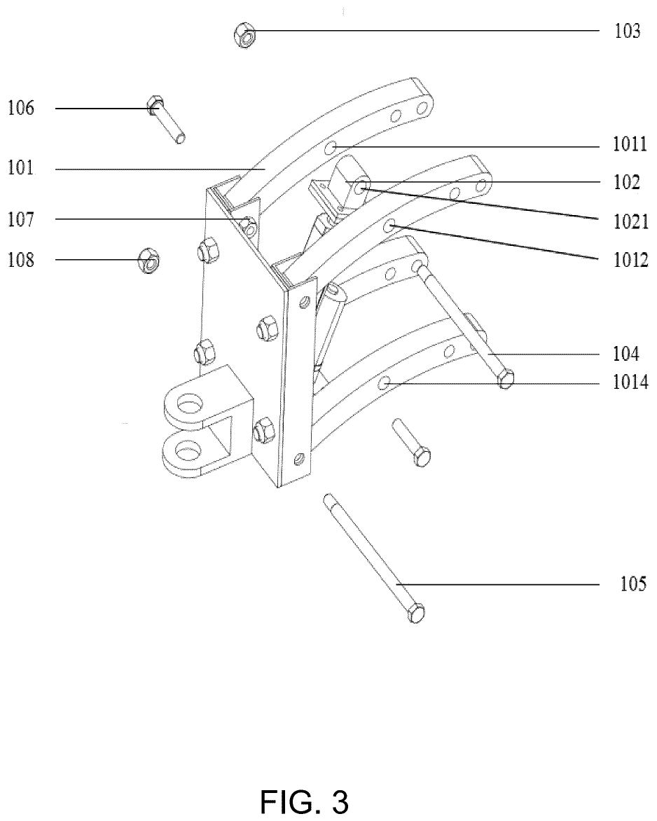

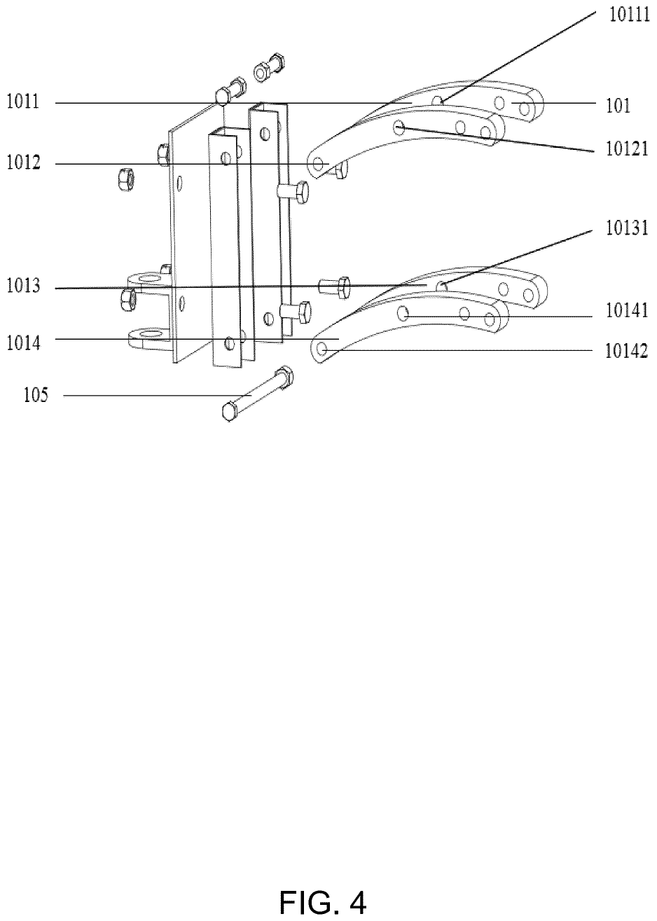

Referring to FIG. 3 and FIG. 4, the profiling ground-following suspension system 1 comprises a four-bar mechanism 101 and an electric push rod 102 for driving the four-bar mechanism. Holes with a diameter of 16-20 mm are respectively formed at the center positions of the first bent rod 1011, the second bent rod 1012, the third bent rod 1013 and the fourth bent rod 1014 of the four-bar mechanism 101, namely, the first hole 10111, the second hole 10121, the third hole 10131 and the fourth hole 10141. The fifth hole 10132 and the sixth hole 10142 with a diameter of 16-20 mm are formed at two sides of the third bent rod 1013 and the fourth bent rod 1014. The seventh hole 1021 and the eighth hole (presumably you missed the specific number here, let's assume it's 1022) with a diameter of 16-20 mm are respectively formed at two ends of the electric push rod 102. A riveting bolt 104 of the profiling ground-following suspension system passes through the first hole 10111, the seventh hole 1021 and the second hole 10121 and is tightened by a first nut 103 to connect the electric push rod 102 with the four-bar mechanism 101. A locking bolt 105 of the profiling ground-following suspension system passes through the fifth hole 10132, the eighth hole 1022 and the sixth hole 10142 and is tightened by a second nut 108 to fix the electric push rod 102 and the four-bar mechanism 101 together. A mounting bolt 106 and a third nut 107 of the profiling ground-following suspension system are used for fixing the first bent rod 1011 and the second bent rod 1012.

The profiling mechanism is adjusted by the electric push rod 102 to move, thereby changing the ground clearance of the frame. The maximum stroke of the electric push rod is 100 mm.

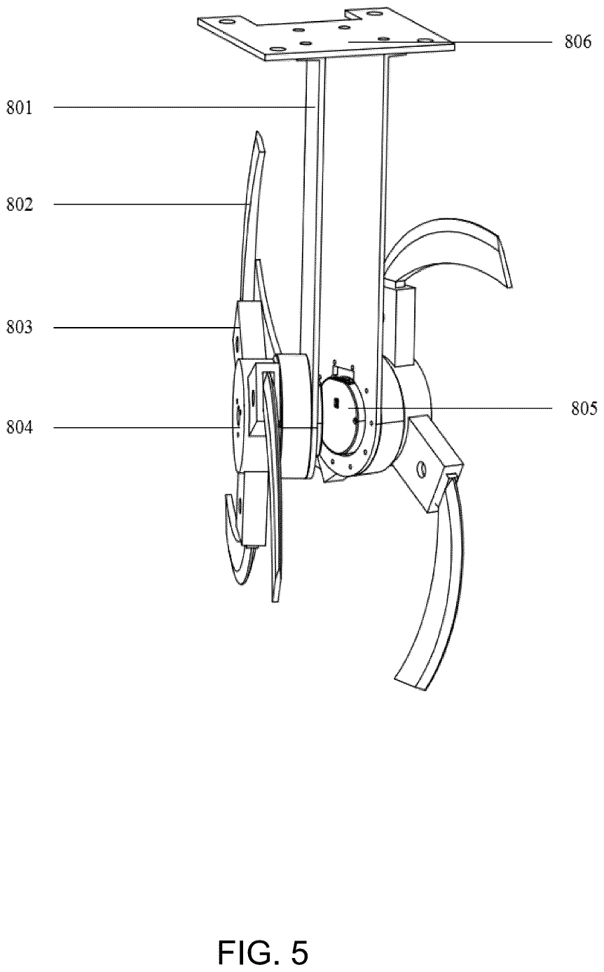

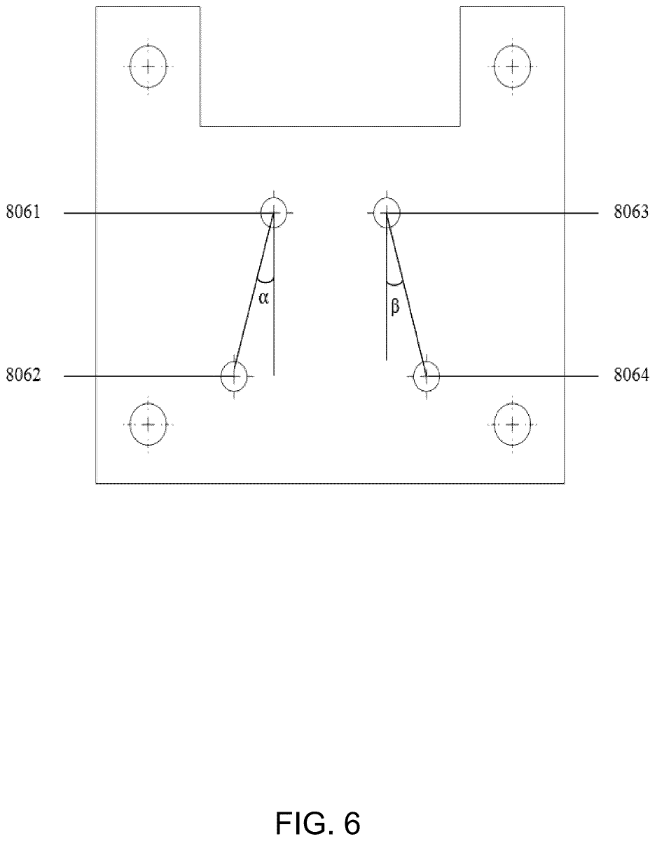

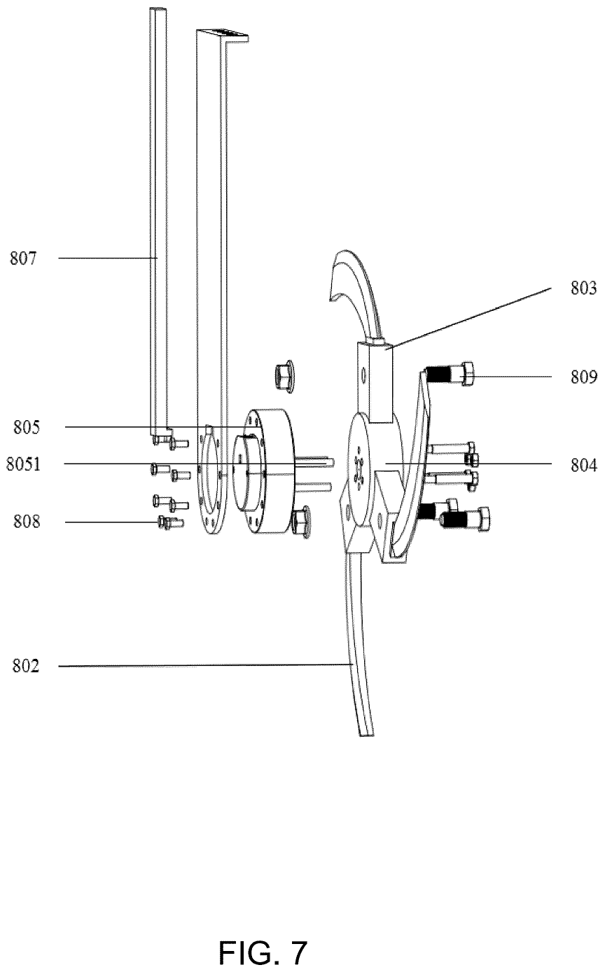

Referring to FIGS. 5 to 7, the inclined rotary tillage blade set 8 includes a rotary tillage blade support arm 801, rotary tillage blades 802, rotary tillage blade seats 803, a rotary tillage blade disc 804, a rotary tillage blade motor 805, a rotary tillage blade top plate 806, a rotary tillage blade power cord 807, a rotary tillage blade motor fixing bolt 808, and a rotary tillage blade fixing bolt 809. The rotary tillage blade disc 804 has six screw holes for fixing the disc 804 to the output shaft 8051 of the rotary tillage blade motor.

The rotary tillage blade top plate 806 is provided with a first hole 8061, a second hole 8062, a third hole 8063, and a fourth hole 8064 for fixing the rotary tillage blade support arm 801. The angle α between the straight line formed by the first hole 8061 and the second hole 8062 and the vertical direction is 10°. The angle β between the straight line formed by the third hole 8063 and the fourth hole 8064 and the vertical direction is 10°. The first hole 8061, the second hole 8062, the third hole 8063, and the fourth hole 8064 of the rotary tillage blade top plate are connected to the corresponding holes on the rotary tillage blade support arm 801 by bolts. By setting the angles of α and β, the purpose of inclining the rotary tillage blade shaft is achieved.

Referring to FIGS. 5 to 7, the inclined rotary tillage blade set 8 includes a rotary tillage blade support arm 801, rotary tillage blades 802, rotary tillage blade seats 803, a rotary tillage blade disc 804, a rotary tillage blade motor 805, a rotary tillage blade top plate 806, a rotary tillage blade power cord 807, a rotary tillage blade motor fixing bolt 808, and a rotary tillage blade fixing bolt 809. The rotary tillage blade disc 804 has six screw holes for fixing the disc 804 to the output shaft 8051 of the rotary tillage blade motor.

The rotary tillage blade top plate 806 is provided with a first hole 8061, a second hole 8062, a third hole 8063, and a fourth hole 8064 for fixing the rotary tillage blade support arm 801. The angle α between the straight line formed by the first hole 8061 and the second hole 8062 and the vertical direction is 10°. The angle β between the straight line formed by the third hole 8063 and the fourth hole 8064 and the vertical direction is 10°. The first hole 8061, the second hole 8062, the third hole 8063, and the fourth hole 8064 of the rotary tillage blade top plate are connected to the corresponding holes on the rotary tillage blade support arm 801 by bolts. By setting the angles of α and β, the purpose of inclining the rotary tillage blade shaft is achieved.

A plurality of rotary tillage blade seats 803 are uniformly and fixedly connected to the cylindrical surface of the rotary tillage blade disc 804, and there is a certain distance between the disc 804 and the rotary tillage blade motor 805. A planar rotary tillage blade 802 is fixedly connected in each rotary tillage blade seat 803. The rotary tillage blades 802 in the inclined rotary tillage blade set 8 are driven by the rotary tillage blade motor 805. The model of the rotary tillage blade motor is MG8008-i9, and the thickness of the rotary tillage blade 802 is only 48 mm.

To further optimize the technical solution, the plane where the rotary tillage blade disc 804 is located has an inclination angle of 80 degrees relative to the vertical plane where the central axis of the seeder is located, and the center-to-center distance between two adjacent discs is 190 mm.

To further optimize the technical solution, the diameter of the rotary tillage blade disc 804 is 45 mm, the turning radius of the rotary tillage blade seat is 100 mm, and the turning radius of the rotary tillage blade 802 is 225 mm.

Both the electric push rod 102 and the pressing wheel adjusting push rod 6 are electric push rods with a stroke of 100 mm and a fully extended length of 305 mm. Their operating voltage is DC 24V.

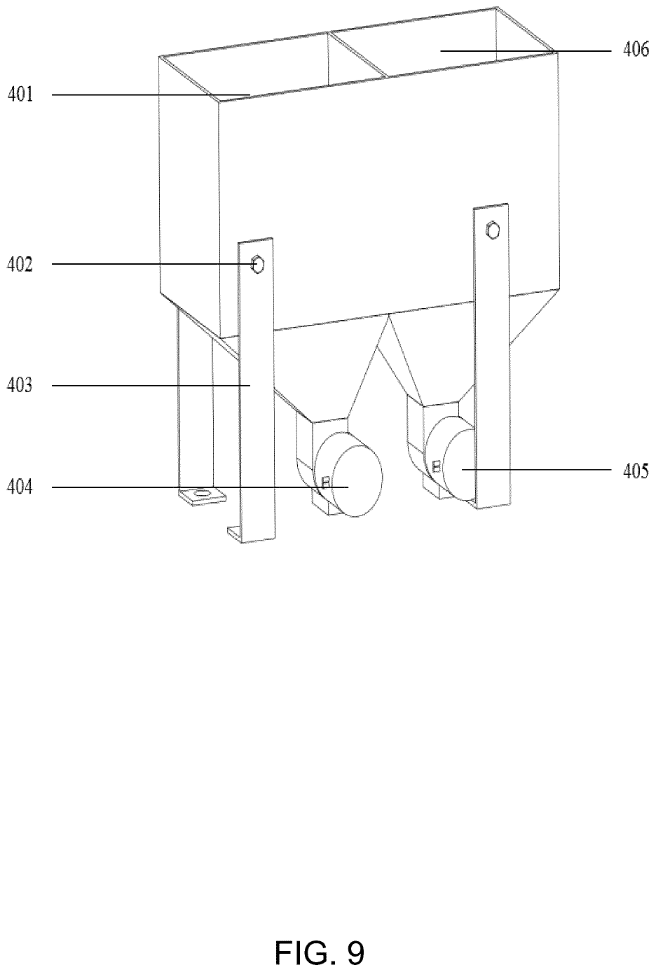

Referring to FIG. 9, the seed-fertilizer box replenishment device 4 comprises a seed box 401, seed box support bolts 402, a seed box support plate 403, a seed metering shaft motor 404, a fertilizer metering shaft motor 405, and a fertilizer box 406. The bottom end of the seed box support plate 403 is fixed on the frame 5. Both the seed box 401 and the fertilizer box 406 are fixedly installed on the seed box support plate 403 through the seed box support bolts 402. The seed metering shaft motor 404 is located at the outlet of the seed box 401 and is used to adjust the rotation speed of the seed metering shaft. The fertilizer metering shaft motor 405 is located at the outlet of the fertilizer box 406 and is used to adjust the rotation speed of the fertilizer metering shaft.

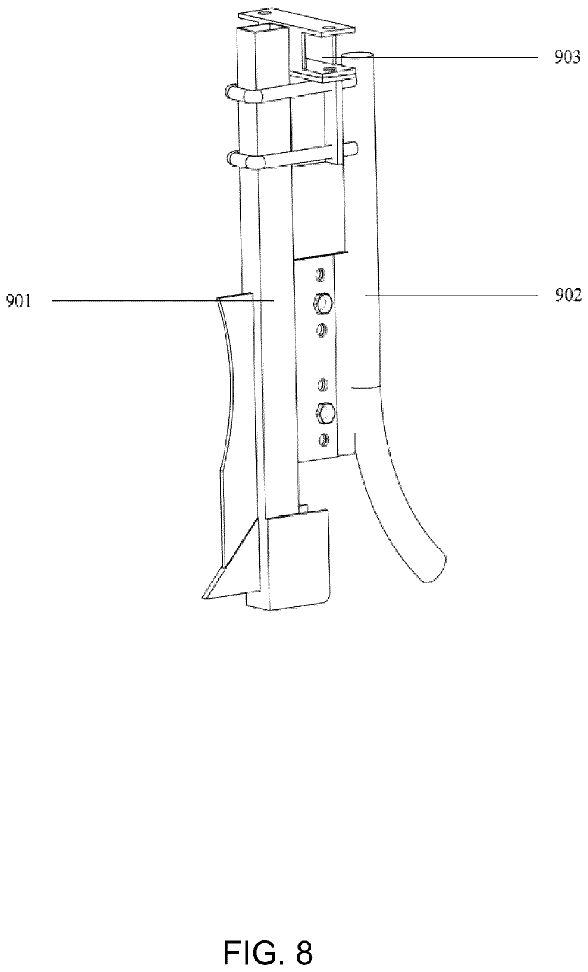

Referring to FIG. 8, the ditching mechanism 9 is located directly behind the inclined rotary tillage blade set 8 of the planetary gear train, and the vertical plane where the ditching mechanism 9 is located coincides with the central axis plane of this single-unit no-till wheat seeder. The ditching mechanism 9 comprises a furrow opener connector 903, a furrow opener 901, and a fertilizer discharge pipe 902. The furrow opener connector 903 is fixed to the frame 5 by bolts. The furrow opener 901 is installed at the front of the furrow opener connector 903 and is in communication with the outlet of the seed box 401. The fertilizer discharge pipe 902 is installed at the rear of the furrow opener connector 903 and is in communication with the outlet of the fertilizer box 406.

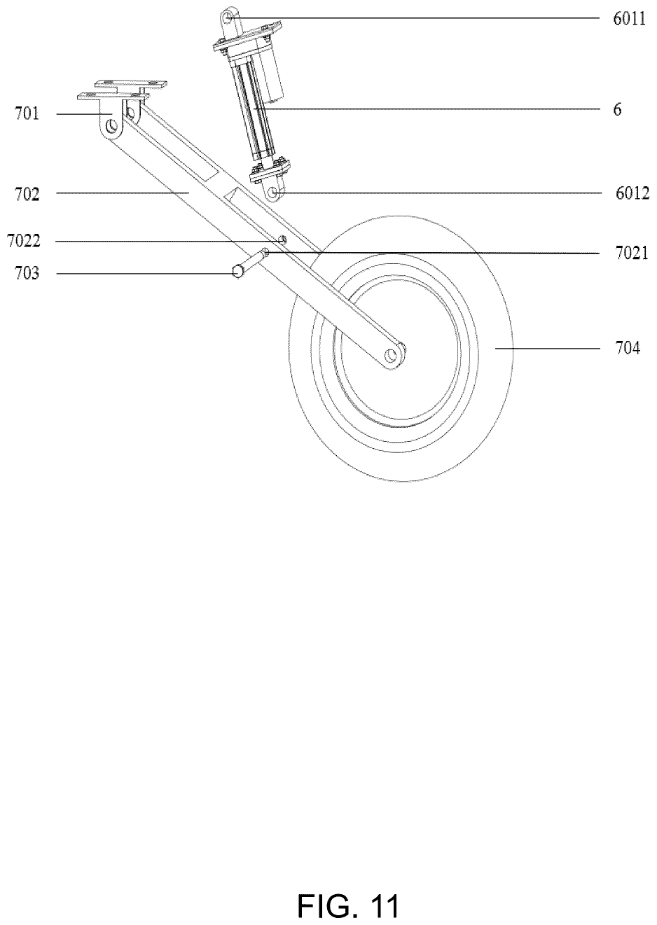

Referring to FIG. 11, the pressing mechanism 7 includes a pressing wheel device support 701, a pressing wheel support arm 702, a pressing wheel connecting bolt 703, a pressing wheel adjusting push rod 6, and a pressing wheel 704. One end of the pressing wheel device support 701 is fixedly installed at the rear of the frame 5, and the other end is rotatably connected to the pressing wheel 704. The pressing wheel adjusting push rod 6 is provided with a ninth hole 6011 and a tenth hole 6012. The pressing wheel support arm 702 is provided with an eleventh hole 7021 and a twelfth hole 7022. The ninth hole 6011 is used for connection with the frame 5. The pressing wheel connecting bolt 703 passes through the eleventh hole 7021, the tenth hole 6012, and the twelfth hole 7022 respectively to connect the pressing wheel adjusting push rod 6 and the pressing wheel support arm 702 together. The distance between the side of the pressing wheel adjusting push rod 6 and the inner side of the pressing wheel support arm 702 is 35-45 mm.

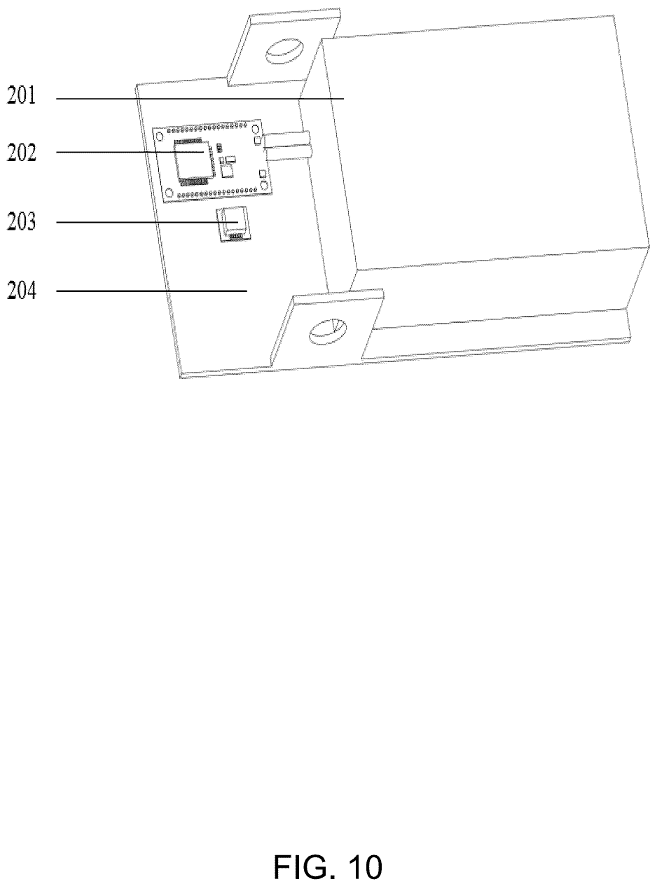

Referring to FIG. 10, the measurement and control device 2 includes a control system power supply 201, an STM32 control board 202, a BMX055 attitude sensor 203 for measuring the attitude and displacement of the frame, a measurement and control device substrate 204, an HC-SR04 ultrasonic sensor 10, and a battery 3 for driving the motors and the measurement and control device. The HC-SR04 ultrasonic sensor 10 is arranged at the bottom of the inclined rotary tillage blade set 8 and is used to measure the ground clearance information of the seeding unit. The measurement and control device substrate 204 and the battery 3 are both installed on the frame 5. The control system power supply 201, the STM32 control board 202, and the BMX055 attitude sensor 203 are all integrated on the measurement and control device substrate 204.

The HC-SR04 ultrasonic sensor 10 is located below the inclined rotary tillage blade set 8 and is connected to the rotary tillage blade support arm 801 by bolts. The measured value h1 represents the height from the bottom of the rotary tillage blade motor 805 to the ground.

The BMX055 attitude sensor 203 is an all-in-one 9-axis sensor module. The measurement and control device can obtain the precise two-axis displacements x and y and the forward speed vm of this single-unit system through the BMX055 attitude sensor.

After obtaining the ground clearance h1 of this seeding unit, the STM32 control board subtracts h1 from the preset ground clearance value h to obtain the ground clearance change value h2=h−h1. Then it drives the four-bar mechanism to adjust the electric push rod 102 to shorten, so as to lower the frame by a height of h2.

The ratio λ of the rotational speed of the rotary tillage blades to the forward speed of the seeder is set to 5, which is determined by the formula λ=Rω/vm. After obtaining the forward speed vm of this seeding unit, substitute it into the formula to get the rotational speed ω of the rotary tillage blades. Then, the controller adjusts the rotational speed of the rotary tillage blades to ω to ensure that the seeding speed matches the forward speed and to achieve the best rotary tillage and anti-blocking quality.

The working process of the present invention is as follows:

During operation, the seeding unit is driven forward by a tractor. Meanwhile, the battery supplies power to the rotary tillage blade motor 803 to drive the rotary tillage blades to rotate. While loosening the soil, since the rotary tillage blades form a certain angle with the forward direction, the straw can be thrown to the rear-side, achieving the purpose of cleaning and preparing the seedbed. During the forward movement, the HC-SR04 ultrasonic sensor 10 measures the ground clearance information of the seeding unit, and the BMX055 attitude sensor 203 collects data such as forward displacement and ground-related displacement. The data from the two sensors will be displayed on the screen panel of the measurement and control device 2.

At the same time, the controller couples the data from the HC-SR04 ultrasonic sensor 10 after denoising processing with the data from the BMX055 attitude sensor 203. The vertical displacement hb collected by the BMX055 attitude sensor 203 is the main factor with a weight of 0.9, and the vertical displacement hh collected by the HC-SR 04 ultrasonic sensor 10 is the auxiliary factor with a weight of 0.1. Through the formula h1=hb×0.9+hh×0.1, the forward speed and ground clearance information h1 of the seeder are obtained after data processing.

After obtaining the ground clearance h1 of the seeding unit, the STM32 control board 202 subtracts h1 from the preset ground clearance value h to obtain the ground clearance change value h2=h−h1. Then it drives the four-bar mechanism to adjust the push rod 102 to shorten or extend, so as to lower the frame by a height of h2, achieving the purpose of profiling and ensuring a consistent seeding depth. At the same time, it drives the pressing wheel adjusting electric push rod 6 to shorten or extend to adjust the pressing force of the pressing wheel.

The ratio λ of the rotational speed of the rotary tillage blades to the forward speed of the seeder is set to 5, which is determined by the formula λ=Rω/vm. After the BMX055 attitude sensor 203 obtains the forward speed vm of the seeding unit, substitute it into the formula to get the rotational speed ω of the rotary tillage blades. Then, the controller adjusts the rotational speed of the rotary tillage blades to ω to ensure that the seeding speed matches the forward speed. At the same time, the STM32 control board 202 adjusts the rotational speeds of the fertilizer-discharging shaft motor 405 and the seed-discharging shaft motor 404 based on the obtained forward speed information to achieve the best seeding effect.

Finally, it should be noted that: the above embodiments are only used to illustrate the technical solutions of the present invention, rather than to limit them. Although the present invention has been described in detail with reference to the foregoing embodiments, those of ordinary skill in the art should understand that they can still modify the technical solutions described in the foregoing embodiments, or perform equivalent replacements for some of the technical features. These modifications or replacements do not cause the essence of the corresponding technical solutions to deviate from the spirit and scope of the technical solutions of the various embodiments of the present invention.

What is claimed is:

1. An intelligent no-till seeding unit for wheat, characterized by comprising: Ground-following suspension system (1), a measurement and control device (2), a seed-fertilizer box replenishment device (4), a frame (5), a pressing mechanism (7), an inclined rotary tillage blade set (8), and a ditching mechanism (9);
The profiling ground-following suspension system (1) is installed at the front part of the frame (5); the seed-fertilizer box replenishment device (4) is installed on the top of the frame (5), the ditching mechanism (9) is installed in the middle of the bottom end of the frame (5) and is communicated with the seed-fertilizer box replenishment device (4); the inclined rotary tillage blade set (8) is installed at the front part of the bottom end of the frame (5), and the pressing mechanism (7) is installed at the rear part of the bottom end of the frame (5). The measurement and control device (2) is installed inside the frame (5) and is electrically connected to the profiling ground-following suspension system (1), the seed-fertilizer box replenishment device (4), the pressing mechanism (7), and the inclined rotary tillage blade set (8) respectively.

2. The intelligent no-till seeding unit for wheat according to claim 1, characterized in that the profiling ground-following suspension system (1) includes a four-bar mechanism (101) and an electric push rod (102) for driving the four-bar mechanism. The central positions of the first bent rod (1011), the second bent rod (1012), the third bent rod (1013), and the fourth bent rod (1014) of the four-bar mechanism (101) are all provided with holes, which are hole one (10111), hole two (10121), hole three (10131), and hole four (10141) respectively; holes five and hole six (10142) are provided at both sides of the third bent rod (1013) and the fourth bent rod (1014); both ends of the electric push rod (102) are provided with hole seven (1021) and hole eight respectively. The riveting bolt of the profiling ground-following suspension system (104) passes through hole one (10111), hole seven (1021), and hole two (10121) and is fastened by nut one (103) to connect the electric push rod and the four-bar mechanism (101) together; the locking bolt of the profiling mechanism (105) passes through hole five (10132), hole eight, and hole six (10142) and is fastened by nut two (108) to fix the electric push rod (102) and the four-bar mechanism (101) together; the installation bolt of the profiling ground-following suspension system (106) and nut three (107) are used to fix the first bent rod (1011) and the second bent rod (1012).

3. The intelligent no-till seeding unit for wheat according to claim 2, characterized in that the inclined rotary tillage blade set (8) includes a rotary tillage blade support arm (801), rotary tillage blade blades (802), rotary tillage blade seats (803), a rotary tillage blade disc (804), a rotary tillage blade motor (805), a rotary tillage blade top plate (806), a rotary tillage blade power cord (807), a rotary tillage blade motor fixing bolt (808), and a rotary tillage blade blade fixing bolt (809). The rotary tillage blade disc (804) has 6 screw hole positions for fixing the disc (804) on the output shaft (8051) of the rotary tillage blade motor;
The rotary tillage blade top plate (806) has a rotary tillage blade top plate hole one (8061), a rotary tillage blade top plate hole two (8062), a rotary tillage blade top plate hole three (8063), and a rotary tillage blade top plate hole four (8064) for fixing the rotary tillage blade support arm (801). The angle α between the straight line formed by the rotary tillage blade top plate hole one (8061) and the rotary tillage blade top plate hole two (8062) and the vertical direction is 10°; the angle β between the straight line formed by the rotary tillage blade top plate hole three (8063) and the rotary tillage blade top plate hole four (8064) and the vertical direction is 10°. The rotary tillage blade top plate hole one (8061), the rotary tillage blade top plate hole two (8062), the rotary tillage blade top plate hole three (8063), and the rotary tillage blade top plate hole four (8064) are connected to the corresponding hole positions on the rotary tillage blade support arm (801) by bolts;
A plurality of rotary tillage blade seats (803) are evenly fixed on the cylindrical surface of the rotary tillage blade disc (804), and there is a certain distance between the disc (804) and the rotary tillage blade motor (805). A planar rotary tillage blade blade (802) is fixed in each rotary tillage blade seat (803).

4. The intelligent no-till seeding unit for wheat according to claim 3, characterized in that the angle between the plane where the rotary tillage blade disc (804) is located and the vertical plane where the central axis of the seeder is located is 80 degrees, and the center-to-center distance between two adjacent discs is 190 mm.

5. The intelligent no-till seeding unit for wheat according to claim 3, characterized in that the diameter of the rotary tillage blade disc (804) is 45 mm, the turning radius of the rotary tillage blade seat is 100 mm, and the turning radius of the rotary tillage blade (802) is 225 mm.

6. The intelligent no-till seeding unit for wheat according to claim 3, characterized in the seed-fertilizer box replenishment device (4) includes a seed box (401), seed box support bolts (402), a seed box support plate (403), a seed-discharging shaft motor (404), a fertilizer-discharging shaft motor (405), and a fertilizer box (406). The bottom end of the seed box support plate (403) is fixed on the frame (5), and the seed box (401) and the fertilizer box (406) are both fixedly installed on the seed box support plate (403) through the seed box support bolts (402). The seed-discharging shaft motor (404) is located at the outlet of the seed box (401) and is used to adjust the rotation speed of the seed-discharging shaft; the fertilizer-discharging shaft motor (405) is located at the outlet of the fertilizer box (406) and is used to adjust the rotation speed of the fertilizer-discharging shaft.

7. The intelligent no-till seeding unit for wheat according to claim 6, characterized in that the ditching mechanism (9) includes a ditching device connector (903), a ditching device (901), and a fertilizer-discharging pipe (902). The ditching device connector (903) is fixed on the frame (5) by bolts; the ditching device (901) is installed at the front part of the ditching device connector (903) and is communicated with the outlet of the seed box (401); the fertilizer-discharging pipe (902) is installed at the rear part of the ditching device connector (903) and is communicated with the outlet of the fertilizer box (406).

8. The intelligent no-till seeding unit for wheat according to claim 5, characterized in that the pressing mechanism (7) includes a pressing wheel device support (701), a pressing wheel support arm (702), a pressing wheel connecting bolt (703), a pressing wheel adjusting push rod (6), and a pressing wheel (704). One end of the pressing wheel device support (701) is fixedly installed at the rear part of the frame (5), and the other end is rotatably connected to the pressing wheel (704). The pressing wheel adjusting push rod (6) is provided with hole nine (6011) and hole ten (6012); the pressing wheel support arm (702) is provided with hole eleven (7021) and hole twelve (7022). The hole nine (6011) is used to connect with the frame (5); the pressing wheel connecting bolt (703) passes through hole eleven (7021), hole ten (6012), and hole twelve (7022) respectively to connect the pressing wheel adjusting push rod (6) and the pressing wheel support arm (702) together.

9. The intelligent no-till seeding unit for wheat according to claim 1, characterized in that the measurement and control device (2) includes a control system power supply (201), an STM32 control board (202), a BMX055 attitude sensor (203) for measuring the attitude and displacement of the frame, a measurement and control device base plate (204), an HC-SR04 ultrasonic sensor (10), and a battery (3). The HC-SR04 ultrasonic sensor (10) is arranged at the bottom of the inclined rotary tillage blade set (8) and is used to measure the ground-clearance information of the seeding unit; the measurement and control device base plate (204) and the battery (3) are both installed on the frame (5), and the control system power supply (201), the STM32 control board (202), and the BMX055 attitude sensor (203) are all integrated on the measurement and control device base plate (204).
